(19) United States
(12) Patent Application Publication
(10) Pub. No.: US 2017/0046647 A1
(43) Pub. Date: Feb. 16, 2017

(54) Methods and Systems for Distributing Goods

(71) Applicant: The Procter & Gamble Company, Cincinnati, OH (US)

(72) Inventors: Lieven Richard Deketele, Zulte (BE); Indrek Ilves, Tallinn (EE)

(21) Appl. No.: 15/335,695

(22) Filed: Oct. 27, 2016

Related U.S. Application Data
(63) Continuation-in-part of application No. 14/717,157, filed on May 20, 2015.

(51) Int. Cl. G06Q 10/06; G06Q 10/08

(52) U.S. Cl. CPC G06Q 10/06315; G06Q 10/087

(57) ABSTRACT

Systems and methods for managing inventory include: defining: a market basket of products, a safety stock quantity limit and a maximum stock quantity limit for at least one product in the defined market basket; providing a user with at least the safety stock quantity of at least one product in the defined market basket; tracking the quantity of at least one product of the defined market basket; receiving an indication associated with the use at least one product; reducing the tracked quantity of product associated with the use indication for that product, by at least one unit; reducing the tracked quantity of any product in the market basket below the safety stock quantity limit for that product according to a received use indication for that product, or a user provided input to reduce the tracked quantity; and providing the consumer with replenishment product(s) for at least a portion of the market basket, up to the defined maximum stock quantity of each product.

### FIELD OF THE INVENTION

The invention relates to systems and methods for distributing goods. The invention relates particularly to systems and methods for distributing fast moving consumer goods to the individuals and businesses which consume those goods.

### BACKGROUND OF THE INVENTION

By definition, consumable goods need to be replenished as they are used. Shopping requires time and organization to ensure that all needed items are purchased prior to running out. Failure to provide timely replenishment results in a situation where there is nothing available for use. Regular shopping may be used to ensure that products are available, and shopper subscription services may be used as well. Subscription services may result in out of stock if the replenishment timing is too slow, and may result in a buildup of unused inventory in the event that the timing is too fast. What is desired is a method for managing the inventory of products available for consumption to prevent an out of stock situation without unnecessarily accumulating extra product.

### SUMMARY OF THE INVENTION

In one aspect, a method for managing inventory includes the steps of: defining a market basket of products; defining a safety stock quantity limit for at least one product in the defined market basket; defining a maximum stock quantity limit for at least one product in the defined market basket; providing a user with at least the safety stock quantity of at least one product in the defined market basket; tracking the quantity of at least one product of the defined market basket;

receiving an indication associated with the use at least one product; reducing the tracked quantity of product associated with the use indication for that product, by at least one unit; reducing the tracked quantity of any product in the market basket below an order triggering quantity limit for that product according to a received use indication for that product; and providing the consumer with replenishment product(s) for at least a portion of the market basket, up to and including the defined maximum stock quantity of each product.

In one aspect, a system includes a memory component that stores logic that, when executed by a processor, causes the system to define a market basket of products; define a safety stock quantity limit for at least one product in the defined market basket; define a maximum stock quantity limit for at least one product in the defined market basket; provide a user with at least the safety stock quantity of at least one product in the defined market basket; track the quantity of at least one product of the defined market basket; receive an indication associated with the use at least one product; reduce the tracked quantity of product associated with the use indication for that product, by one unit, or reduce the tracked quantity according to input provided by the user; reduce the tracked quantity of any product in the market basket to an order trigger quantity for that product according to a received use indication for that product; and provide the consumer with replenishment product(s) for at least a portion of the market basket, up to the defined maximum stock quantity of each product.

In one aspect, embodiments of a computing device, or network of devices, include logic which when executed causes the device or devices to define a market basket of products; define a safety stock quantity limit for at least one product in the defined market basket; define a maximum stock quantity limit for at least one product in the defined market basket; provide a user with at least the safety stock quantity of at least one product in the defined market basket; track the quantity of at least one product of the defined market basket; receive an indication associated with the use of at least one product; reduce the tracked quantity of product associated with the use indication for that product, by one unit; or reduce the tracked quantity according to input provided by the user reduce the tracked quantity of any product in the market basket to an order trigger quantity for that product according to a received use indication for that product; and provide the consumer with replenishment product(s) for at least a portion of the market basket, up to the defined maximum stock quantity of each product.

### DETAILED DESCRIPTION OF THE INVENTION

The following text sets forth a broad description of numerous different embodiments of the present invention. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

The methods of the invention may be executed using computational systems including single computers connected to a network for sending and receiving information necessary to the operation of the steps of the method, or by a system of computers with appropriate communication linkages between them. The devices may also include mobile computing devices, including tablet computers, and smart phones. Dedicated scanning hardware may also be incorporated into the practice of the method when such hardware is available and properly integrated into the communications network associated with the system set up for managing the activities of the method.

Portions of the method may be facilitated by the use of a graphical user interface (GUI) and a networked device controlled by a user of the method. The user may visit a website associated with the method in order to carry out a number of activities to customize their user experience with the activities of the method. The user may provide information to establish a user profile. This information may include their name, address, email address, demographic information about themselves and other members and aspects of their household. The information provided by the user may be used to categorize the user and household from a marketing perspective, i.e. to assign the user and/or household to a particular market demographic. This categorization may subsequently be used, either independently or in conjunction with the user profile, to identify offers on products outside the defined market basket which may be of interest to the user and/or other household members. The user may use the interface to define or select the products they desire to include in their market basket for participation in the program of the method and input related to system defined quantities associated with those products. Both a standard webpage and a mobile device optimized version may be provided.

In one embodiment, the appearance of the GUI may be altered to signify the transition from set-up activities to actual use and shopping via the GUI. The coloration of the display and/or elements presented in the GUI may be altered. The appearance of text and images may be altered as well—as an example, test during set-up may appear gray while text during use and shopping may be black.

The interface may include links to one or more of the products available for inclusion in the market basket. Such links may be used by the user to seek more information regarding available products without a need to leave the interface itself. The links may be collected in an area considered or labeled as the shopping zone or the store. The user may proceed to the store for the purpose of placing items in their shopping basket. As the user selects items for purchase, they may select each item in terms of whether the particular item should be one-off, single purchase, or should be considered part of the items to be replenished as used. Selecting items for replenishment may lead to interface options to set maximum and minimum quantities for the particular item.

The interface may include the option of selecting a starter kit from a set of starter kits. The user may begin using the application by selecting one or more starter kits, preconfigured by the merchant and containing a selection of goods associated with a household size or family situation. Exemplary starter kits include kits optimized for a single individual, kits for a couple, kits for a family with young children and kits for a family with older children. The interface can offer to merely select the pre-configured starter-kit or can also offer to edit that starter-kit.

The method for distributing consumer goods includes the step of defining a market basket having at least one product. The market basket contents may be defined by the shopper, consumer, or user of the products, or may be offered as a predefined combination of products by a manufacturer or retailer of products. A combination of the two origins, where the basket contents comprise both items designated by the intended consumer or shopper, as well as bundled or packages of goods designated by a manufacturer, distributor or retailer may also be defined.

In one embodiment, the user may add items to the basket by scanning the UPC or other barcode of an item. The system may allow the user to set minimum and maximum quantities for the scanned item, alternatively, the system may suggest minimum and maximum quantities for the scanned item. The user may scan such items already in their possession, or items they select in a retail environment, or become aware of through friends, acquaintances, or family The interface may allow the user to provide an indication of any quantity of the selected product already on-hand for use by enabling the adjustment of the current inventory level for the item.

In one embodiment, product websites may incorporate a software widget enabling the viewer of the website to access their system basket to add the product(s) disclosed on the site to their basket. In this embodiment, the user may manually select quantities for mm and max, or may allow the system to specify those quantities.

In one embodiment, the user may provide information to establish additional shipping locations and baskets associated with those locations. In this embodiment, parents may establish locations and baskets for children living away from home. User's may establish locations and baskets for secondary addresses such as work related addresses or vacation addresses, to enable the availability of products and or services at the secondary addresses as well as but independent from the inventories held and used at the primary address.

In one embodiment, the user may establish alternate users having at least partial access to the account and associated basket. Such users may be granted access to the system with reduced permissions, or light, version of the user interface. In one aspect of this embodiment, the light user may provide an indication of the start of use of a product in the basket and may suggest additions to the basket or changes to the product quantities. The indication may be provided by any form of input associated with networked devices including, without limitation, voice commands, motions, touch screen input, keyboard input, image capture, RFID and NFC tag reading. Such suggestions may be subject to review and approval of the main account user, or the holder of full permissions for the account. The primary permission differentiating the light and full versions of access is the permission to purchase items resulting in charges to the account.

The nature of the goods is not a limiting element of the method. Any goods available for purchase and subject to being delivered may be included in the basket. The method is adapted for the beneficial acquisition of fast moving consumable goods but is not limited to their purchase.

For at least one of the market basket goods, up to and including for all market basket goods, a safety stock quantity may be defined. The safety stock quantity may be used to determine the timing of various reorder scenarios for the particular good as well as for other products defined within the basket. For at least one product, and for up to all market basket products, a maximum stock quantity may also be defined. The maximum stock quantity designates the greatest inventory level the method will provide to a particular user for a particular product. The safety and maximum stock quantities for the products may be defined automatically by the inventory management system. The automatic definitions may be based upon an estimated consumption rate for the product balanced against the time to replenish products, or may be based upon historical usage information associated with the product. The limits may be made accessible to the user of the method, allowing the user to adjust the limits if they so desire. Exemplary safety stock quantities include quantities of zero, or one unit of the goods, and may include consideration of the time required to replenish the goods after an order is triggered. Exemplary maximum stock limit quantities vary according to the rate of consumption of the good by the end consumer, and the quantity of space available for storing unused goods. The limits may be modified over time using user input, product usage history, shipping times, or combinations of those factors as inputs to ensure that the user will not suffer out of stock situations for the products while also not maintain excessive on-hand stock levels.

In one embodiment, the system may suggest increasing the maximum stock of a product by 1 or more, if that product was consecutively responsible for triggering an order (for example triggered 3 of the last 5 orders). Analogously, if a product never triggered an order, the maximum quantity can be reduced by 1. Similarly, the system may consider the product usage over a past period, and based on the usage, suggest increasing or decreasing maximum stock and safety stock.

In one embodiment, the user might choose to order quantities of product higher than the maximum stock. The system may then monitor the actual quantity but will not suggest including it in a triggered order until the actual quantity drops below the maximum stock for this product.

Once the stock quantities are defined, the user may be provided with at least a portion of the market basket contents. In one embodiment, the user may be provided the maximum stock quantity of each product in the basket. In one embodiment, the user may be provided with less than the maximum quantity of the market basket for logistical reasons—a desire to limit the amount shipped/received in each order, or financial reasons, a desire to stagger the full cost of the entire market basket at maximum stock quantities, out over time. The safety stock limit for at least one item may be provided to the user as the low extreme of the first shipment associated with the methods use.

In association with the shipment of goods to the user, records of the quantity of each good shipped are maintained in accordance with the method. As additional product is provided, the records are updated according to the items provided as part of the initial provision of the market basket or as part of replenishing the market basket until the records indicate that the maximum stock quantity of each product in the basket having defined limits, is available to the user. By these steps, the method administration system acquires an initial and then ongoing quantity for each shipped good for each participating user.

As the user/consumer makes use of the received product, an indication of their use, whether it is an indication of the start of use, or completion of their use—the product is gone—may be provided to the administrative system managing the method. The indication of use may be provided overtly by the user engaging a computer network and sending the information explicitly to the administration system via a text or email or other formal communication effort. In one embodiment, the user may use an input device to provide the indication. A dedicated input device, linked to a network and associated with a particular product, e.g.: a member of the “internet of things” may be used to provide the indication. In this embodiment, the device may be disposed at a location associated with the indication, at or near the point of use of the good, at or near the point of disposal of the used product package or the secondary package removed at the start of use.

The user may provide the indication via a mobile device, such as a smart phone, and may use a software application provided in association with the method to utilize hardware capabilities of the device to provide the indication. As an example, the application software may enable the use of the camera of a phone to capture an image of the product or packaging, the application may then use image analysis to identify the product in comparison to stored images or images available via a network connection. The image may be limited to a UPC code upon the package, or unique artwork provided upon the package enabling the identification of the product. Analysis of the image may lead to information analogous to the product which may then be passed over a network connection as an indication of use of the product.

In one embodiment, the user may use voice input to describe the desired product. The user may provide a complete description of the desired product at the outset, or may provide a limited initial description at the outset and proceed with additional portions of the description as prompted by the software. As an example, the user may provide a brand name, then as prompted, provide a sub-brand, a scent or flavor and a package size, etc., as prompted by the software.

In one embodiment, a label or sticker may be fixedly, or releasably attached to the product or package for the purpose of reminding the user to provide the indication of use and also to facilitate the provision by providing an object to scan in association with the use. In one embodiment, the releasably attached label or sticker may provide a duplicate of the UPC code for the product, or other indicia, enabling the user to remove the duplicate for the purpose of accumulating a plurality of UPC duplicates for use later in providing a number of indications of use at a single point in time. As an example, a household may determine that it is best to save a week's worth of stickers until a single common time for providing the indication as a mean of keeping the house organized.

After the indication has been sent, the system receives the indication and uses the information to reduce the recorded quantity associated with the relevant products by the indicated number of units—generally one unit, possibly more.

In one embodiment, the user may manually provide input to reduce the tracked quantity. In this embodiment, the user may provide input to alter the tracked quantities to reconcile any differences between the tracked and actual quantities associated with a particular product. The user input may be provided in the form of tapping on the device touch screen, entering information via a keyboard, providing information via a voice command for the app, through a gesture or pre-defined motion of an input device, including a smartphone, and other known input forms.

This reduction in the recorded quantity may result in an order trigger due to a reduction of that quantity to, or below the safety stock limit. The choice of algorithm, as to the trigger occurring at a reduction to the safety stock limit as opposed to a reduction below the safety stock limit will influence the choice of safety stock limit. Either choice may be effectively used by the method.

As or after the order triggering quantity is reached and the order trigger occurs, the user will be provided with replenishment goods or will be suggested to order a pre-suggested editable order. One or more units of the good associated with the order trigger (trigger good), as well as any goods in the market basket having a recorded inventory level below the maximum stock quantity limit may be provided in the order. The excess space remaining in a designated shipping container associated with the provision of the trigger good may be used as an input in determining which market basket goods will be provided together with the trigger good and the respective quantities of each provided good.

In one embodiment, quantities of each good in the market basket sufficient to raise the recorded inventory levels of the entire market basket to the maximum stock quantity limit may be provided. In one embodiment, only quantities of the trigger good sufficient to raise the recorded inventory level of that particular product above the order trigger point may be provided. In many instances, quantities of market basket goods between these two extremes may be provided.

In one embodiment, one or more designated products of the market basket may be out of stock, or may be discontinued. In this embodiment, the system may identify a similar good considered as a suitable replacement for the unavailable good and the new good may be substituted in the replenishment order. Alternatively, the user may be notified of the discontinuity and provided an opportunity to select an alternative to the discontinued product or to choose to cease receiving any product in the market category of the discontinued product. Automation of the replacement may be selected by the user as a setting of the overall system.

Substitution of goods may be necessary in instances where the original good is no longer produced, or in instances where the retailers are out of stock of the particular good. Each of these cases may be presented to the user in a unique visual context, enabling the user to easily grasp the nature of the circumstances necessitating the substitution, In one embodiment, the good may be out of stock, in this embodiment, the original good and the recommended or selected replacement good may be shown together with the original product in bold and the replacement in a grayed out manner For goods which are permanently unavailable due to manufacturing changes, the old good may appear grayed out while the newly recommended or selected good may be bold or otherwise highlighted.

The software may be in communication with both the manufacturer and Distributors/Retailers affording the software access to information regarding which products are temporarily unavailable and which ones are permanently unavailable.

The method also includes the optional step of utilizing unoccupied space in a shipping container associated with a particular order for the purpose of providing the user a sample of a product outside those of the market basket. The particular sample product may be determined according to the current marketing activities of the system provider as well as information about the user and the particular products defined as the user's market basket. The unoccupied space may alternatively be filled with dunnage or with notices of offers from the system administrator or other organizations in cooperation with the administrator.

Once the order has been defined, the user may be notified via a communication using text, email, voicemail, or other communication means, that the order is ready for shipment pending their acceptance of the selected order items. As, or after, verification of acceptance is received from the user, the order may be shipped. The affirmation of the user may further include information sufficient to facilitate payment in association with the order. The payment may occur prior to or subsequent to the receipt of the order by the user. In one embodiment, the payment may be made to a supplier of the goods and not to the administrator of the order and distribution management system.

In one embodiment, the user may choose to select an option to defer the receipt of a notice prior to the shipment and may enable the supplier to ship the order and request payment automatically according to pre-established means for the payment and without confirmation from the user.

A user may provide an indication of use as products from a previously triggered order are in transit but not yet received. In this instance, the system of the method may consider the recorded quantity of each particular good to include the unused quantity of the good held by the user as well as any quantity in transit to the user due to the previously triggered order. In this manner, the quantity recorded by the system as held by the user will be maintained at a level at or below the maximum quantity stock limit associated with that product. The actual quantity held by the user may be less than the quantity recorded for the use due to the inclusion of the in-transit products.

The actual provision of either or both the initial quantities of goods and replenishment quantities, may be made by the administrator of the system, or by a supplier designated by the user and integrated into the steps of the method. In this embodiment, the user may provide information associated with one or more suppliers to the administration system sufficient for the system to integrate the supplier(s) into the method. Information sufficient to enable the system and the supplier to identify the user may be provided. In this manner, there may be no need for a user to provide sensitive payment information to the system administration element as such information may be currently held by the designated supplier and associated with the identified user. In one embodiment, a user may provide a supplier's name and an account number sufficient to identify the user to the supplier. A set of suppliers may be designated and may be divided by a user's preference for use, or for use by different elements of the market basket, or a combination thereof. Once such supplier(s) have been designated, the actual provision of goods may be completed by the supplier(s) at the direction of the system. As an example, once an order has been triggered, approved, and the contents of the order have been determined by the system, the defined order may be passed to the supplier for fulfillment to the user.

The system may consider and optimize the provision of market basket goods according to a set of supplier-centric factors. In one embodiment, criteria including product availability (is it in stock now, at the moment of the order?), listing (does the retailer carry the item), price (is the price attractive compared to other retailers?), etc., the order is placed with that supplier, out of the list of designated suppliers that is, at the moment of ordering, best matching the needs of the consumer.

The provision of the goods may be made by shipping the goods to the user, or alternatively, by providing the goods at a designated drop-off, pick-up point, where the user may access them. The use of a drop-off, pick-up combination may allow the provider to stage high usage items for distribution at the site. Such staging may permit the rapid fulfillment of orders for such goods.

Upon receipt of the initial and replenishment products, the user may provide an indication to the system that this receipt has occurred. The user may provide this indication for each item individually, or the user may be provided with an option to indicate receipt of the entire order with a single action. The documents provided with the shipment may include a scannable element which may be recognized by the software as indicating receipt of all items in the associated shipment/order. As items are indicated as received, the user may be provided an option to alter the max and mm inventory levels for the product as well as an option to alter the status of the product with regard to replenishment. This information may be used to gauge the time required for replenishment orders to be received and to alter the status of products considered in-transit to: received. The information may be provided using the user interface, email, telephone or the mobile device of the user and indicia included with the product order for the purpose of enabling this communication. As an example, the shipping carton may include external or internal indicia suggesting that the user scans it to provide notice to the system that the products have been received. Any suitable indicia may be used including labels, stickers or direct printed indicia. The indicia may be serialized or otherwise uniquely associated with the particular order.

In one aspect, the user of the system may be a professional service provider and the system may be used to manage their inventory of consumable products associated with providing services. As an example, an individual hair stylist, or a styling salon, may use the methods and systems of the invention to monitor and manage the inventory level of products necessary for their services. In such an embodiment, the system may further utilize an additional stock quantity associated with the standard shipping of a product. As an example, in the case of a hair colorant product, which may be shipped in case quantities, wherein each case contains a number of individual units of the product, the tracking and use of the case quantity as well as the safety and maximum stock quantities. As the product is used, the system may be notified as the case is opened and as each unit from the case is used. In this embodiment, the system may be configured such that the safety stock limit relates to the number of individual units remaining unused, whereas the shipping quantity may relate to the case quantity and not to individual unit quantities. Similarly, the services of the method may be used by professional cleaning services, pet care service providers, day-care providers, health-care, various retail outlets, dental providers, and other known service and goods providers.

In one embodiment, the method includes functionality for sharing product and application information among users. A first user may be asked to provide product information by a second user. The first user may select the appropriate product using the interface and the software interface may provide the option of sharing the information with another user. The sharing options may include using the email, Gmail™, or SMS messaging applications of the user's devices, as well as direct link options such as bluetooth™, pairing, or Android Beam™, or other NFC communications protocols, to transfer information about the product from one use to the other. The shared information may include product descriptions, images, prices and also information about the replenishment application. In this manner, a first user may share not only the details about the specific product they use, but also further details about the manner in which they procure the goods, including a link to the software distribution channel where the application may be obtained.

In one embodiment, the first and second users may pair their devices with each having the application open and the first user may then share product information using gestures programmed in the application calling the functionality of transferring the relevant file information from the first device to the second device. In this manner, a first user may for example swipe right to send product information to a second user of the application.

The option to share links of the software may be available at the product level as well as at the other locations in the software interface including the user entry page.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for managing consumer goods inventory, the method comprising providing by a computing system a platform for executing the steps of:
a. defining a consumer market basket of products;
b. defining a safety stock quantity limit for at least one product in the defined market basket;
c. defining a maximum stock quantity limit for at least one product in the defined market basket;
d. providing a consumer with at least the safety stock quantity of at least one product in the defined market basket;
e. tracking the quantity of packages of at least one product of the defined market basket;
f. receiving an indication associated with the start of use of at least one product;
g. reducing the tracked quantity of packages of product associated with the start of use indication for that product, by one unit;
h. reducing the tracked quantity of any product in the market basket below an order triggering quantity limit for that product according to at least one of: a received start of use indication for that product and a user provided input to reduce the tracked quantity; and
i. providing the consumer with replenishment products for at least a portion of the market basket, up to the defined maximum stock quantity of each product.

2. The method according to claim 1 further comprising the step of updating records associated with the quantity of products available to the consumer according to those items that are included in the portion of the market basket replenished.

3. The method according to claim 1 wherein the step of: providing the consumer with replenishment products sufficient to return at least a portion of the market basket products to their defined maximum stock quantity, comprises providing a transitional product replacing a previous defined market basket product.

4. The method according to claim 1, further comprising the steps of:
j. receiving from the consumer a designation of a specified supplier; and
k. having the specified supplier provide defined market basket products to the consumer.

5. The method according to claim 1 further comprising the step of including a product outside the defined-market-basket when providing the consumer with replenishment products.

6. The method according to claim 1 further comprising the step of providing a network user interface for the consumer to receive information regarding the method steps and provide input to the method.

7. The method according to claim 6 wherein the user interface is provided via a software application and a mobile computing device.

8. The method according to claim 6 further comprising providing a linkage between the user interface and a webpage or other network location associated with at least one defined market basket product.

9. The method according to claim 1 wherein the step of receiving an indication associated with the start of use of at least one product comprises receiving the indication from a mobile computing device associated with the consumer.

10. The method according to claim 9 further comprising the step of receiving information analogous to data acquired by the mobile computing device associated with the consumer.

11. The method according to claim 1 further comprising steps of:
l. defining a user profile associated with at least one consumer;
m. providing product offers to the at least one user according to the defined user profile.

12. The method according to claim 9 further comprising steps of:
n. associating at least one consumer with a particular market demographic;
o. providing offers to the at least one consumer according to a combination of their user profile and market demographic.

13. The method according to claim 1 further comprising the step of altering at least one of the safety stock quantity or maximum stock quantity according to consumer product usage history.

14. The method according to claim 1 further comprising the step of attaching a sticker to remind consumers to indicate the start of use of the product package.

15. The method according to claim 1 further comprising the step of providing an indicia upon a product or package, wherein the indicia indicates that the product may be acquired through the method.

16. The method according to claim 1 further comprising the step of including a duplicate of an indicia to enable the consumer to conveniently indicate the start of use of the product package without having to have the package at hand.

17. A computing device for providing a programming platform for a third party programmer comprising:
a. a processor; and
b. a memory component that stores logic that, when executed by the processor, causes the computing device to perform the following:
i. define a consumer market basket of products;
ii. define a safety stock quantity limit for at least one product in the defined market basket;
iii. define a maximum stock quantity limit for at least one product in the defined market basket;
iv. provide a consumer with at least the safety stock quantity of at least one product in the defined market basket;
v. track the quantity of packages of at least one product of the defined market basket;
vi. receive an indication associated with the start of use at least one product;
vii. reduce the tracked quantity of packages of product associated with the start of use indication for that product, by one unit;
viii. reduce the tracked quantity of any product in the market basket below an order triggering quantity limit for that product according to at least one of: a received start of use indication for that product and a user provided input to reduce the tracked quantity; and
ix. provide the consumer with replenishment products for at least a portion of the market basket, up to the defined maximum stock quantity of each product.

18. A system for providing a programming platform for a third party programmer comprising a memory component that stores logic that, when executed by a processor, causes the system to perform at least the following:
a. define a consumer market basket of products;
b. define a safety stock quantity limit for at least one product in the defined market basket;
c. define a maximum stock quantity limit for at least one product in the defined market basket;
d. provide a consumer with at least the safety stock quantity of at least one product in the defined market basket;
e. track the quantity of packages of at least one product of the defined market basket;
f. receive an indication associated with the start of use at least one product;
g. reduce the tracked quantity of packages of product associated with the start of use indication for that product, by one unit;
h. reduce the tracked quantity of any product in the market basket below an order triggering quantity limit for that product according to at least one of: a received start of use indication for that product and a user provided input to reduce the tracked quantity and
i. provide the consumer with replenishment products for at least a portion of the market basket, up to the defined maximum stock quantity of each product.
